(19) United States
(12) Patent Application Publication
(10) Pub. No.: US 2010/0104029 A1
(43) Pub. Date: Apr. 29, 2010

(54) INDEPENDENT LINK(S) OVER DIFFERENTIAL PAIRS USING COMMON-MODE SIGNALING

(76) Inventors: Inyeol Lee, Saratoga, CA (US); Daeyun Shim, Saratoga, CA (US); Ook Kim, Palo Alto, CA (US); Gyudong Kim, Sunnyvale, CA (US)

Correspondence Address: SILICON IMAGE/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/603,176

(22) Filed: Oct. 21, 2009

Related U.S. Application Data
(60) Provisional application No. 61/108,757, filed on Oct. 27, 2008.

(51) Int. Cl. H04L 27/00; H04L 25/00; H04B 3/00

(52) U.S. Cl. 375/257; 375/295

(57) ABSTRACT

Methods and apparatuses for using single-ended common mode signaling, additional data can be transferred in backward, forward, and/or both directions over an existing differential pair connection without adding extra wire.

### PRIORITY

This U.S. patent application claims priority to and incorporates by reference the corresponding U.S. provisional patent application Ser. No. 61/108,757, titled, “INDEPENDENT LINK(S) OVER DIFFERENTIAL PAIRS USING COMMON-MODE SIGNALING,” filed on Oct. 27, 2008.

### BACKGROUND

Differential signaling may be used to send serial data over a cable. To increase data transfer rate, two or more differential pairs are may be used in a high-speed serial link. FIG. 1 illustrates one example system for creating a virtual differential pair using two differential pairs. In the computer system, processor 101 includes transmitter 106 and receiver 110. The processor transmits digital pixel to video display terminal 102 using, for example, the Transition Minimized Differential Signaling (TMDS) communications protocol. Accordingly, processor 101 is coupled to video display terminal 102 through four twisted wire differential pairs 105a-d. Twisted wire differential pairs 105a-d may be implemented within a single cable assembly.

Alternatively, processor 101 may transfer digital pixel data to video display terminal 102 using any other appropriate communications protocol (such as Low-Voltage Differential Signaling, or LVDS), in which case the number of twisted wire differential pairs which are coupled between processor 101 and video display terminal 102 may be different. These twisted wire differential pairs are used to transmit red, green and blue digital pixel data to video display terminal 102, along with a clock signal for synchronizing the data.

Display terminal 102 includes receiver 107, transmitter 115 and DC offset module 125. Receiver 107 receives incoming digital pixel data and routes the data to row and column driver circuitry within display terminal 102. Transmitter 115 in display terminal 102 receives incoming digital data from peripherals which may be coupled to display terminal 102 and transmits this digital data to processor 101 using DC offset module 125. DC offset module 125 is used to manipulate the DC offsets on two of twisted wire differential pairs 105a-d. When the DC offsets in each of the two twisted wire pairs are compared, the difference between the two DC offsets is used to transmit digital data in a reverse direction.

Both wires in a first pair may have their DC offset adjusted by a small amount while the DC offset in both wires of a second pair remains unchanged. The first DC offset is compared with the second offset in order to communicate digital formation in the reverse direction. Further, both wires in the second pair may have their DC offset adjusted by a small amount while the DC offset in both wires of the first pair remains unchanged. The first DC offset is compared with the second offset in order to communicate digital information in the reverse direction. This allows for the bidirectional transfer of digital data. Digital data is also transferred in a reverse direction over two of the twisted wire differential pairs, 140 and 150.

### BRIEF DESCRIPTION OF THE DRAWINGS

The invention is illustrated by way of example, and not by way of limitation, in the figures of the accompanying drawings in which like reference numerals refer to similar elements.

FIG. 1 illustrates a system that incorporates a bidirectional data transfer system.

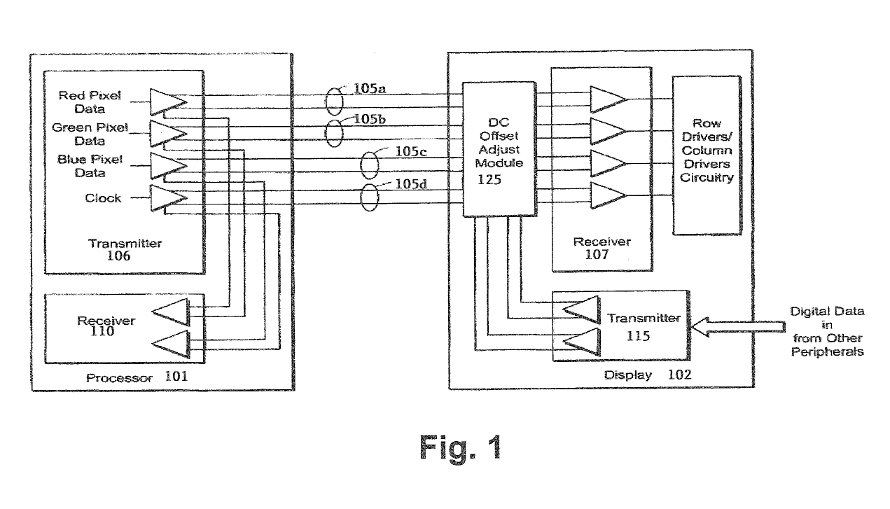

FIG. 2 is a block diagram of one embodiment of a system that incorporates a bidirectional data transfer system utilizing common mode signaling.

FIG. 3 is an example waveform that may be created using the techniques described herein.

FIG. 4 illustrates one embodiment of a transmitter and receiver connected by a cable that may communicate utilizing common-mode signaling.

FIG. 5 illustrates one embodiment of a transmission circuit that may be utilized in a dual-mode receiver.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

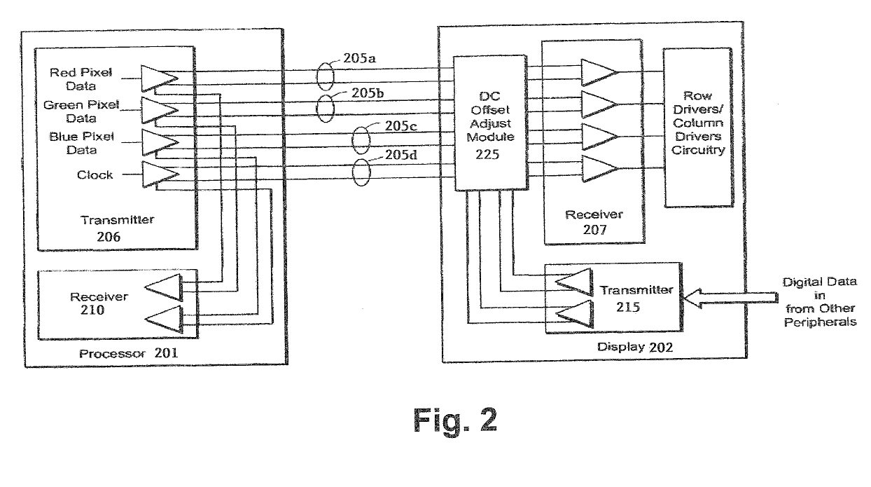

In the common-mode signaling configuration illustrated in FIG. 2, pairs of differential pairs are utilized to create a virtual differential pair. That is, four wires are utilized to provide the virtual differential pair. Further, the data transmission over the virtual differential pair is uni-directional. In the configurations described below, data can be transmitted over a differential pair using common-mode voltage signaling. That is, in addition to the differential pair data transfer signal, another data transfer signal may be provided by the common-mode voltage of the differential pair. Data can be sent data uni-directionally or bi-directionally.

FIG. 2 is a block diagram of one embodiment of a system that incorporates a bidirectional data transfer system utilizing common mode signaling. This scheme modulates the common mode of two differential pairs in opposite directions to represent a bit and detects the common mode differential between those two pairs to recover the bit.

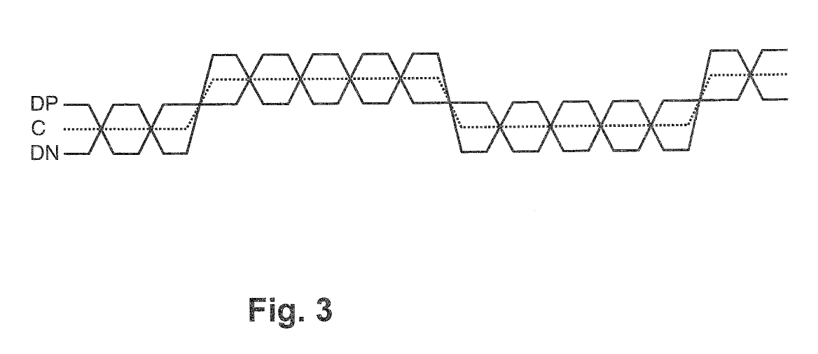

In the example of FIG. 2, the additional virtual differential pair is illustrated as transmitting from processor 201 to display 202. In alternate embodiments, transmission can be from display device 202 to processor 201, or bi-directional communications. The transmitter of FIG. 3 (described in greater detail below) may be utilized to provide additional data transmission capacity over differential pairs 205a-d.

In the computer system of FIG. 2, processor 201 includes transmitter 206 and receiver 210. Processor 201 transmits digital data (e.g., digital pixel data) to display terminal 202 using, for example, the Transition Minimized Differential Signaling (TMDS) communications protocol. Processor 201 is coupled to display terminal 202 through a wired interface that includes at least four differential pairs 205a-d. Differential pairs 205a-d may be implemented within a single cable assembly. In one embodiment, the four differential pairs carry red pixel data, green pixel data, blue pixel data and a clock signal. Other data may also be carried using differential pairs. The differential pairs may take the form or twisted wire pairs.

Alternatively, processor 201 may transfer digital pixel data to video display terminal 202 using any other appropriate communications protocol (e.g., LVDS), in which case the number of differential pairs between processor 201 and video display terminal 202 may be different. These differential pairs may be used to transmit red, green and blue digital pixel data to display terminal 202, along with a clock signal for synchronizing the data.

Display terminal 202 includes receiver 207, transmitter 215 and DC offset module 225. Receiver 207 receives incoming data and routes the data to row and column driver circuitry 230. Transmitter 215 in display 202 may receive incoming data from peripherals which may be coupled to display terminal 202 and may transmit this data to processor 201 using DC offset module 225. DC offset module 225 operates to manipulate the DC offsets on two of differential pairs 105a-d. When the DC offsets in each of the two twisted wire pairs are compared, the difference between the two DC offsets is used to transmit digital data from display 202 to processor 201.

Manipulation of the DC offsets by transmitter 215 allows for transmission of data over pairs of differential pairs to create virtual differential pairs 280 and 290. While the transmission is illustrated as from display device 202 to processor 201, a transmitter may be included in processor 201 and a receiver in display device 202 to allow for transmission over the virtual differential pairs from processor 201 to display device 202. Further, bi-directional communications may be supported over the virtual differential pairs.

Both wires in a first pair may have their DC offset adjusted by a small amount while the DC offset in both wires of a second pair remains unchanged. The first DC offset is compared with the second offset in order to communicate digital formation in the reverse direction. Further, both wires in the second pair may have their DC offset adjusted by a small amount while the DC offset in both wires of the first pair remains unchanged. The first DC offset is compared with the second offset in order to communicate digital information in the reverse direction. This allows for the bidirectional transfer of digital data. Digital data is also transferred in a reverse direction over two of the twisted wire differential pairs, 240 and 250.

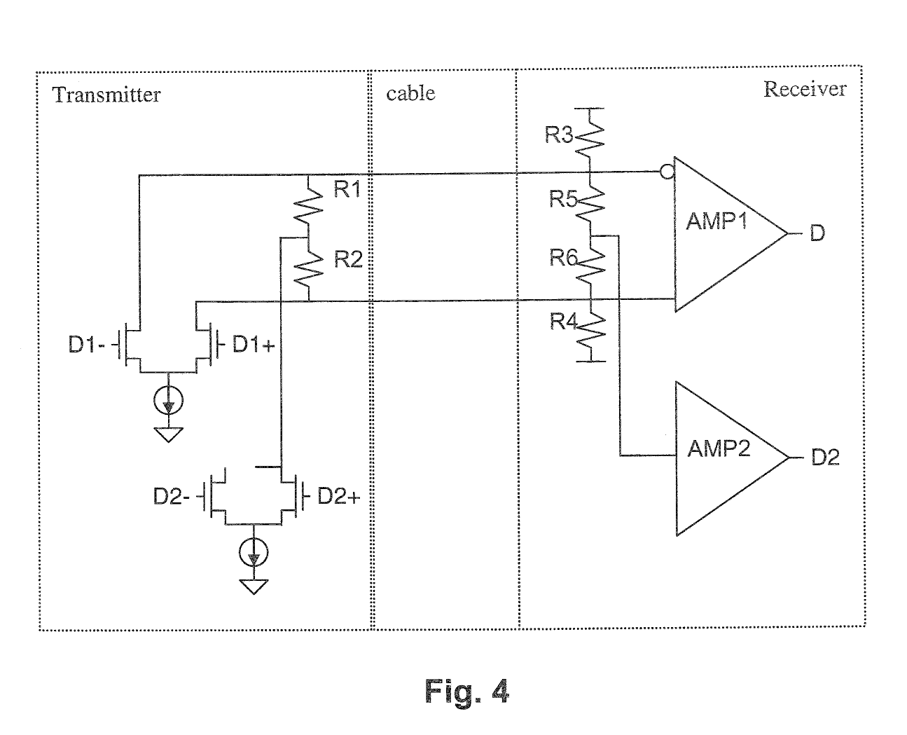

In order to transmit the additional data transmitter 215 may mix data from a first data stream and a second data stream to generate a signal to be transmitted over a differential pair that represents both data streams via differential data with common-mode signaling. Receiver 210 decodes the differential data and common-mode signaling to recover the two data streams. Using the transmitter circuitry described with respect to FIGS. 3 and 4, two data streams may be transmitted over a single differential pair.

FIG. 3 is an example waveform that may be created using these techniques. The signaling techniques and devices described herein are applicable to any differential pair data transfer mechanism, for example, MHL (Mobile High-Definition Link) over micro-USB (Universal Serial Bus) cable, so that both clock and data signals may be transmitted via a single pair of differential wires of a USB cable, or a dual-mode receiver that receives both MHL signals described above, and conventional HDMI signals.

In FIG. 3, DP and DN are differential signals, as indicated by the solid lines. The differential part of these two waveform V_{diff}=(DP−DN) delivers one data stream D1, which is decoded as 10101010 . . . from above example. The common-mode part V_{common}=(DP+DN)/2, which is drawn as a dashed line C, delivers another data stream D2, which is decoded as 000111110000011.

Because this common-mode voltage variation in a differential pair does not significantly affect differential data transfer, the differential and common-mode can be independent. Data can be sent data uni-directionally or bi-directionally. A different signal swing can be used for differential and common-mode signals. The signals can have different data rates. In the example of FIG. 3, the data rate of the common-mode data signal is much less than the data rate of the differential pair data signal.

FIG. 4 illustrates one embodiment of a transmitter and receiver connected by cable 400 that may communicate utilizing both wired differential pair and common-mode signaling, for example, by sending two unidirectional data streams D1 and D2. In general, FIG. 4 consists of three parts—a transmitter which mixes data stream D1 and D2 to generate differential data with common-mode signaling, a differential pair cable, and a receiver which separates differential and common-mode signal and recovers data stream D1 and D2. In the example of FIG. 4, D1 corresponds to the differential pair data signal and D2 corresponds to the common mode data signal.

A current switch circuit driven by D2+ and D2− modulates common-mode of differential pair via resistors R1 and R2. R1 and R2 also serve as differential source termination, thus the ideal value would be half of differential impedance of the cable. Resistors R3 and R4 serve as termination for the common-mode signal, thus the ideal value would be twice the common-mode impedance of the cable for termination impedance matching.

Resistors R5 and R6 extract common-mode voltage. They are also part of differential termination network composed of R3, R4, R5, and R6, thus the ideal value should meet this formula for differential impedance matching with the cable:

Z_{differential}=(R3+R4)//(R5+R6)

Differential amplifier AMP1 recovers data stream D1, and single-ended amplifier AMP2 recovers data stream D2.

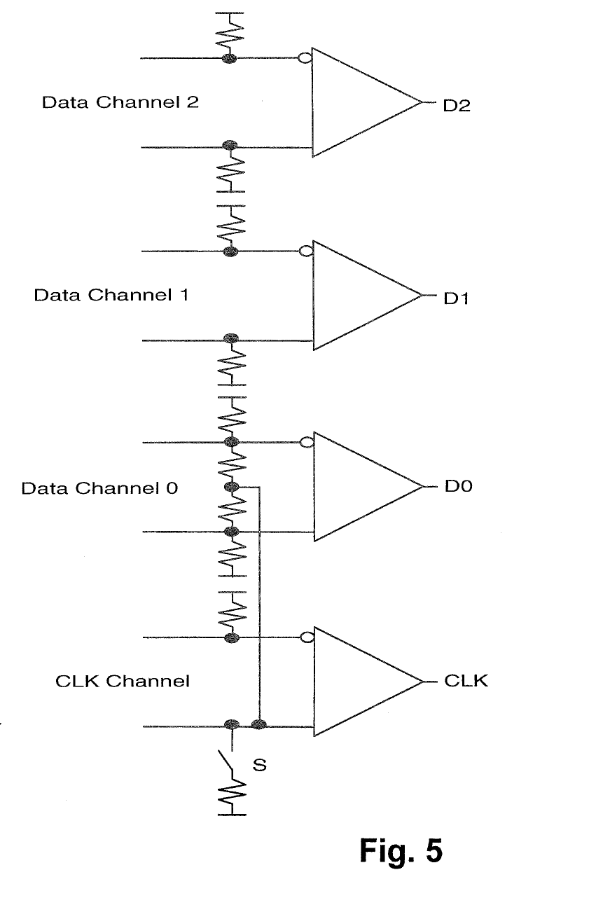

FIG. 5 illustrates one embodiment of a transmission circuit that may be utilized in a dual-mode receiver. The example of FIG. 5 may be used, for example, with a MHL/HDMI dual-mode receiver. The concept of the example of FIG. 5 may be applied to other dual-mode environments as well.

In one embodiment, for HDMI mode, switch S is connected, which causes the receiver to work as a conventional HDMI receiver, getting four differential signal from CLK channel and Data Channel 0,1,2, and delivers CLK, D0, D1, D2 to system. For MHL mode, differential data with common mode clk signal added is applied to Data channel 0, all the other inputs—Clk Channel, Data channel 1 and 2—are floating, also the switch S is disconnected. Then the configuration is the same as described above and recovers CLK and D0.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. A transmitter comprising:
a first signal generation circuit to generate a first data signal that communicates a first data stream via a differential voltage pair signal over a pair of lines; and
a second signal generation circuit a second data signal that communicates a second data stream via a common mode voltage signal, wherein the common mode voltage signal is transmitted the pair of lines concurrent with the differential pair signal.

2. The transmitter of claim 1 wherein the first signal generation circuit comprises at least a first current switch circuit to modulate the differential voltage pair signal.

3. The transmitter of claim 2 wherein the second signal generation circuit comprises at least a second current switch circuit to modulate the common mode voltage signal.

4. The transmitter of claim 3 further comprising a pair of resistive structures coupled in series between the pair of lines, wherein a first of the pair of resistive structures is coupled between an output of the second current switch circuit and a first line in the pair of lines and a second of the pair of resistive structures is coupled between the output of the second current element and a second line in the pair of lines.

5. The transmitter of claim 1 wherein the pair of lines are included in a Universal Serial Bus (USB)-compliant cable.

6. The transmitter of claim 5 wherein the USB-compliant cable comprises a Micro-USB-compliant cable.

7. The transmitter of claim 5 wherein the pair of lines are included in a Mobile High Definition Link (MHL) interface over a Micro-USB cable.

8. The transmitter of claim 5 differential voltage pair signals comprise HDMI signals.

9. A system comprising:
a first signal generation circuit to generate a first data signal that communicates a first data stream via a differential voltage pair signal over a pair of lines;
a second signal generation circuit a second data signal that communicates a second data stream via a common mode voltage signal, wherein the common mode voltage signal is transmitted the pair of lines concurrent with the differential pair signal;
a first amplifier coupled with the pair of lines to extract the differential voltage pair signal; and
a second amplifier coupled with the pair of lines to extract the common mode voltage signal.

10. The system of claim 9 wherein the first signal generation circuit comprises at least a first current switch circuit to modulate the differential voltage pair signal.

11. The system of claim 10 wherein the second signal generation circuit comprises at least a second current switch circuit to modulate the common mode voltage signal.

12. The system of claim 11 further comprising a pair of resistive structures coupled in series between the pair of lines, wherein a first of the pair of resistive structures is coupled between an output of the second current switch circuit and a first line in the pair of lines and a second of the pair of resistive structures is coupled between the output of the second current element and a second line in the pair of lines.

13. The system of claim 9 wherein the first amplifier is coupled to receive signals from each of the pair of lines and the second amplifier is coupled to receive the common mode voltage signal via a resistive structure coupled between the pair of lines.

14. The system of claim 9 wherein the pair of lines are included in a Universal Serial Bus (USB)-compliant cable.

15. The system of claim 9 wherein the USB-compliant cable comprises a Micro-USB-compliant cable.

16. The system of claim 9 wherein the pair of lines are included in a Mobile High Definition Link (MHL) interface over a Micro-USB cable.

17. The system of claim 9 differential voltage pair signals comprise HDMI signals.

18. A method comprising:
transmitting a first signal over a pair of lines using voltage differential signaling by causing a voltage differential between the pair of lines to indicate data values of the first signal;
transmitting a second signal over the pair of lines using common mode voltage signaling by varying a common voltage level for the pair of lines to indicate data values of the second signal.

19. The method of claim 18 wherein the pair of lines are included in a Universal Serial Bus (USB)-compliant cable.

20. The method of claim 18 wherein the USB-compliant cable comprises a Micro-USB-compliant cable.

21. The system of claim 18 wherein the pair of lines are included in a Mobile High Definition Link (MHL) interface over a Micro-USB cable.

22. The system of claim 18 differential voltage pair signals comprise HDMI signals.
